(19) United States
(12) Patent Application Publication
(10) Pub. No.: US 2004/0045838 A1
(43) Pub. Date: Mar. 11, 2004

(54) Water treatment process and apparatus

(76) Inventors: David Napper, Thorso (DK); Lene Rubner-Petersen, Kolding (DK)

Correspondence Address: Andrus Sceales, Starke & Sawall, Suite 100, 100 East Wisconsin Avenue, Milwaukee, WI, 53202, US

(21) Appl. No.: 10/380,098

(22) PCT Filed: Sep. 12, 2001
(86) PCT No.: PCT/EP01/10977

(30) Foreign Application Priority Data
Sep. 12, 2000 (DK) 2000 00274

(51) Int. Cl. C02F 1/461

(52) U.S. Cl. 205/701; 204/242; 205/742

(57) ABSTRACT

A water treatment process subjects raw water, for instance in a recirculating heat exchange, for instance cooling, system sequentially and immediately to an ion exchange step of a biocide step, the biocide step involving treatment in an electrochemical reactor. The biocide step contacts ion exchange water with a pair of electrodes in the presence of a catalyst, for instance platinum. The process provides efficient avoidance of microorganism build-up and minimises regeneration times. Water flows through inlet (1) downwards through a bed of ion exchange resin in ion exchange unit (2), directly into electrochemical reactor (3) comprising alternating corrugated anodes and cathodes connected by d.c. power supply (4) and out of outlet (5).

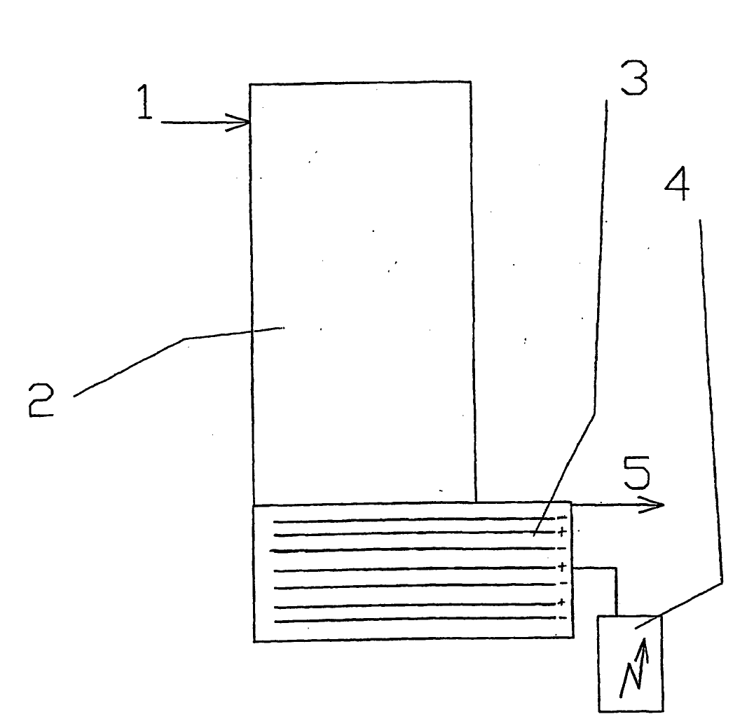

The present invention relates to a process for treating raw water to remov ions and microorganisms, and apparatus suitable for carrying out the process.

There is a need to pretreat process water to remove unwanted ions and to remove microorganisms. For instance in food production or the cosmetics industry, where the water used becomes a significant part of the product, and the product must often have a long shelf life, it is essential to reduce the level of microorganisms to avoid spoilage. In industrial or domestic cooling systems or heating systems, where water is recirculated, it is important to remove ions which may cause scale formation, and microorganisms, which might otherwise attach to and grow on surfaces, forming biofilm and subsequently corrosion of underlying surfaces. For treatment of water to produce potable water, it is often required to remove hardness ions as well as microorganisms.

Ion removal may be conducted using thermal methods, involving distillation, or by chemical methods, for instance by precipitating the hardness ions in apparatus from which the solid may easily be removed. In another class of processes, ions are removed in methods involving semipermeable membranes or ion exchange resins. Processes involving membranes include reverse osmosis and electroosmosis, each using semipermeable membranes. Processes involving ion exchange resins involve passage of water over resin particles, fibres or sheets formed of ionomers having exchangeable counterions. Multivalent hardness ions may be exchanged with monovalent anions and cations or multi- or mono-valent ions may be exchanged for hydrogen ions and hydroxyl ions for complete deionisation. The ion exchange resins are regenerated periodically and reused.

A problem with processes involving the use of resins, especially particulate ion exchange resins, is that they form good substrates for attachment and growth of microorganisms. Such microorganisms form a reservoir, from which cells may be transferred in the flowing water to other surfaces in the system.

The system that has traditionally been used in water treatment has often consisted of a softening or deionisation ion exchange unit followed by one or a series of units to kill and/or remove bacteria. One unit which has traditionally been used as the biocide unit is reverse osmosis. However reverse osmosis is an expensive process in terms of energy and water in regeneration of the m mbranes.

In EP-A-0997437 a reactor for treating liquids by electrochemical means is described. The reactor contains a series of plate shaped corrugated reaction electrodes, means to flow water through the unit, means to pass electricity between the electrodes through the water, as well as means for measuring the conductivity and organic contents of treated water. It is disclosed that the reactor may be included in heat exchanger insulations, or purification systems for waste water.

In a new process according to the invention raw water is subjected sequentially and immediately to an ion-exchange step and a biocide step, characterised in that in the biocide step the ion-exchanged water is contacted with a pair of electrodes of between which a potential difference exists in the presence of a catalyst.

In the process of the invention, the biocide step follows immediately (that is without intervening process steps) after the ion exchange step. As far as we are aware, it has not previously been suggested to incorporate a biocide step involving an electrochemical reactor immediately after an ion exchange step. The electrochemical reactor is suitably of the type described in EP-A-0997437.

The process of the invention is of particular use where the raw water has a total salt content of at least 100 mg l⁻¹, for instance more than 250 mg l⁻¹, such as 500 mg l¹⁻ or more, and/or a hardness of more than 1 degree, for instance 10 degrees or more. The raw water may or may not have a significant organic content. The process is of particular value where the water exiting the ion exchange step has microorganism content of more than 10 c.f.u ml⁻¹, determined using DS/EN ISO 6222-2000, for instance more than 10³ or 10⁵ cfu ml⁻¹. The water exiting the biocide step should have a reduced microorganism content of less than 10 cfu ml⁻¹, as well as a hardness value less than 1 degree.

The ion exchange step preferably involves passage of the raw water through one or a series of beds of particulate resin. The resin may exchange multi-valent (hardness) ions for mono-valent ions or may replace multi- and mono-valent anions and cations with, respectively, hydroxyl and hydrogen ions. Since such resins are reused, the process generally involves a regeneration step as the resin becomes exhausted. Such regeneration steps are known in the art.

In the biocide step, preferably the ion-exchanged water is passed between a series of plate shaped, corrugated reaction electrodes with a volume speed which is above a minimum to prevent dissociation into constituent gases but suffici nt to ensure interaction with an electrical current passing between the reaction electrodes, which are electrically insulat d against each other, the reactor being particular in that it comprises at least one and preferably more interconnected units with series of plate shaped electrodes, valve means and holes in the plates for redirecting the liquid flow into and through the series of reaction electrodes, and an automatic electronic control system consisting of a number of sensors at the liquid inlet of the reactor for measuring the conductivity of the treated liquid, the organic contents of the liquid and the flow (volume) of the liquid, means for transferring the measurements to a processor for further treatment, and means for transferring the output commands from the processor to the valve means for redirecting the liquid flow and for activating or deactivating the electrode unit or units in dependence on the measured parameters.

The catalyst is conveniently provided at the surface of at least some of the electrodes. Preferably the catalyst is a conductor of electricity, so that the entire surface of those electrodes may be coated with catalyst. Suitable catalysts include titanium and platinum metals, titanium dioxide, nickel oxide and lead oxides. Selection of the specific catalyst depends to some degree on the pH of the raw water.

The reactor may have other features as disclosed in EP-A-0997437. Thus the electrodes may form a stack of plates, preferably arranged substantially horizontally, and held together with tie rods. Holes at the edges of the plates form conduits for water, the arrangement of the holes allowing the flow to be directed between electrodes as desired. The stack may comprise alternating cathodes and anodes, with appropriate insulation and liquid seals positioned between them. The flow of water may be split into parallel streams, or may pass between each pair of electrodes in the series.

The potential between the cathodes and anodes should generally be substantially constant, for instance in the range 1 to 100V, preferably in the range 10 to 50V, for instance 12 or 24V. The power source is thus preferably a 12 or 24V d.c. source.

The flow of water through the process is conveniently in the range 0.1 to 10 l s₋₁, preferably 0.25 to 1.0 l s⁻¹. With this range of water flows, the surface area of electrodes is preferably in the range 0.1 to 5, preferably 0.25 to 1, m² (being the total area of the anode and the total area of the cathode, individually). The rate of flow of water, based on electrode surface area, is preferably 1 l m⁻² s⁻¹. The current density of flow of current through the water between the electrodes is preferably in the range 1 to 25 mA cm⁻², preferably in the range 5 to 8 mA cm⁻². When the potential difference is 12V, the energy usage is in the range 60 to 100 mW cm⁻². For instance, for a unit treating 1.5 m³ water per hour the energy consumption is about 0.4 kW, to maintain a microorganism content below 10 cfu ml⁻¹.

According to a further aspect of the invention there is provided an apparatus suitable for carrying out the new process comprising an ion-exchange unit, an inlet for raw water into the ion-exchange unit, a conduit for passage of water from the ion-exchange unit directly to a biocide unit, an outlet for water from the biocide unit and means for flowing water through the ion-exchange unit and the biocide unit, characterised in that the biocide unit comprises an anode and a cathode, between which water may flow whilst in contact with the electrodes, means for passing electricity between the anode and the cathode, and a catalyst in contact with water flowing between the electrodes.

It is convenient for the apparatus to be provided in a single housing which contains both units. The conduit between the two units may even be provided in a single vessel, for instance comprising a plate separator having openings for passage of water. It is generally convenient for there to be sensing means for monitoring the quality of water between the ion exchange unit and the biocide unit. The sensing means may allow for sampling of the water passing between the two units, or may monitor the bulk water in one of the vessels or the conduit between them. Suitable sensing means comprise conductivity meters. Where the monitoring involves determining the organic content, or the microorganism content, it is general for the water to be sampled and to be subjected to suitable measurement, for instance using standard test method number DS/EN ISO 6222-2000.

The apparatus may further be provided with sensing means to determine the quality of inlet water, and water exiting from the apparatus. Such means are known in the art.

The power source used in the apparatus for passing electricity through the electrodes is generally a d.c. source. For instance a 12V or 24V source. Means are provided for monitoring the current. Means may be provided for controlling the level of current flow, or the selection of electrodes for current flow at any particular time, for instance based upon the water quality of inlet and product water. Similarly the flow rate and/or selection of electrodes between which the flow should be passed, may be controlled, for instance in response to water quality control measurements.

The invention is illustrated further in the accompanying figure, which is a schematic representation of apparatus according to the invention.

A water-softening unit 2 is positioned above and attached to a biocide unit 3. The water-softening unit 2 comprises a bed of resin particles, through which water flows generally downwardly. Raw water is passed through inlet pipe 1 through the resin particles towards biocide unit 3. Inside biocide unit 3, corrugated anodes and cathodes are arranged in an alternating stack, the plates being substantially horizontal. The plates are formed of stainless steel, with a platinum catalyst coating provided on the surface of the anode. Water is pumped through the biocide unit, whilst current is passed between electrodes by power source shown generally as 4. Treated water is removed through outlet 5.

The power source for the apparatus shown is a 12V d.c. source. The electrodes have a size of (per cathode, per anode) of 425 cm⁻². There are six anodes and seven cathodes arranged in an alternating stack i.e. with a total of electrode surface area of about 0.5 m² between each pair of opposite polarity electrodes. Water flows through the whole apparatus at a rate of about 0.42 ls⁻¹, the flow being split between 12 parallel flows between pairs of anode and cathode. The current density between the electrodes is 5 to 8 mA cm⁻² and the electrodes are separated by a distance in the range 1.5-2.0 mm, energy usage is about 300-500W or, based on the volume of water about 1 kW l⁻¹.

The apparatus of the invention is suitable for treating raw water having a hardness of 5-25 degrees and a total salt (inorganic) content of about 500 mg l⁻¹, to produce treated water having a hardness less than 1 degree, and a microorganism content of less than 10 cfu ml⁻¹. As compared to a comparative system in which reverse osmosis follows a water-softening unit, the energy consumption is reduced by as much as 75 or 80%, for product water of the same quality and the process avoids the consumption of extra water and production of waste water. The reactor requires little maintenance, and little in the way of waste product, as well as being energy efficient.

1. A water treatment process in which raw water is subjected sequentially and immediately to an ion-exchange step and a biocide step, characterised in that in the biocide step the ion-exchanged water is contacted with a pair of electrodes of between which a potential difference exists in the presence of a catalyst.

2. A process according to claim 1 in which the raw water has a hardness in the range 5 to 25 degrees, the deionised or ion-exchanged water has a hardness less than 1 degree and the treated water exiting the biocide step has a reduced microorganism content of less than 10 cfu ml⁻¹.

3. A process according to claim 1 or claim 2 in which the first step is a deionisation step carried out by passing the raw water through at least one bed of particulate ion exchange resin.

4. A process according to any preceding claim in which the treated water is recirculating water.

5. A process according to any of claims 1 to 3 in which the treated water is process water for incorporation into food or cosmetics products.

6. A process according to any preceding claim in which the potential difference between the pair of electrodes is in the range 10-100V, preferably 12 to 24V.

7. A process according to any preceding claim in which current flows through the water between the electrodes at a current density in the range 1 to 25 mA cm⁻², preferably in the range 5-8 mA cm⁻².

8. A process according to any preceding claim in which water is treated at a rate of 0.25-1.0 l s⁻¹, and in which the electricity consumption is in the range 0.5-2.0 W l⁻¹.

9. A process according to claim 8 in which the water flows between electrodes the sets of anodes and cathodes each having a total surface area in the range of 0.1 to 2 m² cm², arranged substantially horizontally and positioned 1.5-2 mm apart, measured vertically;

10. A water treatment apparatus comprising an ion-exchange unit, an inlet for raw water into the ion-exchange unit, a conduit for passage of water from the ion-exchange unit directly to a biocide unit, an outlet for water from the biocide unit and means for flowing water through the ion-exchange unit and the biocide unit, characterised in that the biocide unit comprises an anode and a cathode, between which water may flow whilst in contact with the electrodes, means for passing electricity between the anode and the cathode, and a catalyst in contact with water flowing between the electrodes.

11. Apparatus according to claim 10 in which the ion-exchange unit comprises a bed of ion-exchange resin.

12. Apparatus according to claim 10 or claim 11 in which the catalyst is coated on one of the electrodes, preferably the anode.

13. Apparatus according to any of claims 10 to 12 in which the catalyst is selected from platinum, titanium, nickel oxide and lead oxide.

14. Apparatus according to any of claims 10 to 13 in which the means for passing electricity is suitable to create a potential difference between anode and cathode in the range 10 to 100V, preferably 12 to 24V.

15. Apparatus according to any of claims 10 to 14 in which the anode and cathode are corrugated with the same shape, wavelength and amplitude and have their waves aligned so the facing surfaces are parallel to one another.

16. Apparatus according to claim 15 in which the distance between the electrodes is in the 1.5 to 2 mm and in which the facing electrode surfaces have a total surface area in the range 0.1 to 5 m², preferably 0.2 to 1 m².

17. Apparatus according to any of claims 10 to 16 in which the means for passing electricity between the electrodes is a d.c. power source.
